(19) United States
(12) Patent Application Publication
(10) Pub. No.: US 2011/0120261 A1
(43) Pub. Date: May 26, 2011

(54) CONNECTING ROD AND METHOD OF MANUFACTURING THEREOF

(75) Inventors: Christopher R. Abreu, Simpsonville, SC (US); Anthony P. Copper, Greenville, SC (US)

(73) Assignee: KOYO BEARINGS USA LLC, Westlake, OH (US)

(21) Appl. No.: 12/844,946

(22) Filed: Jul. 28, 2010

Related U.S. Application Data
(60) Provisional application No. 61/264,329, filed on Nov. 25, 2009.

(51) Int. Cl. F16C 7/02; B21D 53/84

(52) U.S. Cl. 74/579 R; 29/888.09

(57) ABSTRACT

A method of manufacturing a connecting rod includes providing a substantially cylindrical rough bore in one end of the connecting rod, applying one of a compressive load and a tensile load to the connecting rod to at least partially deform the rough bore to a non-cylindrical shape, and machining the deformed rough bore to a substantially cylindrical shape while the one of the compressive load and the tensile load is applied to the connecting rod.

### CLAIM OF PRIORITY

This application claims priority to U.S. Provisional Application Ser. No. 61/264,329, filed Nov. 25, 2009, the entire disclosure of which is incorporated by reference herein.

### FIELD OF THE INVENTION

The present invention relates to internal combustion engines, and more particularly to connecting rods for use in internal combustion engines.

### BACKGROUND OF THE INVENTION

Internal combustion engines typically include connecting rods for converting the reciprocating motion of pistons to rotation of a crankshaft. Some engines utilize roller bearings between the connecting rods and respective journals on the crankshaft to facilitate relative rotation between the connecting rods and the crankshaft. Inertial loading of the connecting rods during an exhaust stroke or a compression stroke of the associated piston, or compression loading of the connecting rod during a power stroke of the associated piston, typically causes a bore within the connecting rod within which the roller bearings are positioned to deform. This, in turn, reduces the length of the contact zone in which the roller bearings contact both the crankshaft journal and the connecting rod to transfer forces between the crankshaft journal and the connecting rod. As a result of this shortened contact zone, the roller bearings are typically subjected to a varying distribution of stress, and sometimes momentary peak stresses, which may result in a reduced useful life of the roller bearings.

### SUMMARY OF THE INVENTION

The present invention provides, in one aspect, a method of manufacturing a connecting rod including providing a substantially cylindrical rough bore in one end of the connecting rod, applying one of a compressive load and a tensile load to the connecting rod to at least partially deform the rough bore to a non-cylindrical shape, and machining the deformed rough bore to a substantially cylindrical shape while the one of the compressive load and the tensile load is applied to the connecting rod.

The present invention provides, in another aspect, a connecting rod including a body defining a longitudinal axis, a cap coupled to the body, and a non-cylindrical, finished bore defined at least partially by the body and the cap. The finished bore defines a central axis oriented substantially normal to the longitudinal axis. The finished bore has a cross-sectional shape through a plane oriented substantially normal to the central axis. The cross-sectional shape has a minimum, first radius and a maximum, second radius with respect to the central axis. The radius of the cross-sectional shape continuously increases from the first radius to the second radius.

The present invention provides, in yet another aspect, a connecting rod including a body defining a longitudinal axis, a cap coupled to the body, and an oblong, finished bore defined at least partially by the body and the cap. The finished bore defines a central axis oriented substantially normal to the longitudinal axis. The finished bore includes a cross-sectional shape through a plane oriented substantially normal to the central axis. The cross-sectional shape of the finished bore has a major axis and a minor axis. One of the major axis and the minor axis is oriented substantially parallel with the longitudinal axis. A chord bounded by the cross-sectional shape of the finished bore and intersecting the central axis continuously decreases in length from a first orientation, in which the chord is aligned with the major axis, to a second orientation, in which the chord is aligned with the minor axis, as the chord is rotated about the central axis.

Other features and aspects of the invention will become apparent by consideration of the following detailed description and accompanying drawings.

### BRIEF DESCRIPTION OF THE DRAWINGS

FIG. 1A is a front view of a connecting rod having a substantially cylindrical rough bore in one end of the rod.

FIG. 1B is a front view of the connecting rod of FIG. 1A, with a compression load applied to the connecting rod to at least partially deform the substantially cylindrical rough bore.

FIG. 1C is a front view of the connecting rod of FIG. 1B, illustrating the deformed rough bore machined to a substantially cylindrical shape while the compression load is applied to the connecting rod.

FIG. 1D is a front view of the connecting rod of FIG. 1C, illustrating the compression load removed from the connecting rod to allow the finished bore to elastically rebound to an oblong shape.

FIG. 2A is a front view of a connecting rod having a substantially cylindrical rough bore in one end of the rod.

FIG. 2B is a front view of the connecting rod of FIG. 2A, with a tensile load applied to the connecting rod to at least partially deform the substantially cylindrical rough bore.

FIG. 2C is a front view of the connecting rod of FIG. 2B, illustrating the deformed rough bore machined to a substantially cylindrical shape while the tensile load is applied to the connecting rod.

FIG. 2D is a front view of the connecting rod of FIG. 2C, illustrating the tensile load removed from the connecting rod to allow the finished bore to elastically rebound to an oblong shape.

FIG. 3A is a front view of a connecting rod having a substantially cylindrical rough bore in one end of the rod.

FIG. 3B is a front view of the connecting rod of FIG. 3A, with a compression load applied to the connecting rod to at least partially deform the substantially cylindrical rough bore.

FIG. 3C is a front view of the connecting rod of FIG. 3B, illustrating the deformed rough bore machined to a substantially cylindrical shape while the compression load is applied to the connecting rod.

FIG. 3D is a front view of the connecting rod of FIG. 3C, illustrating the compression load removed from the connecting rod to allow the finished bore to elastically rebound to a non-cylindrical shape.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

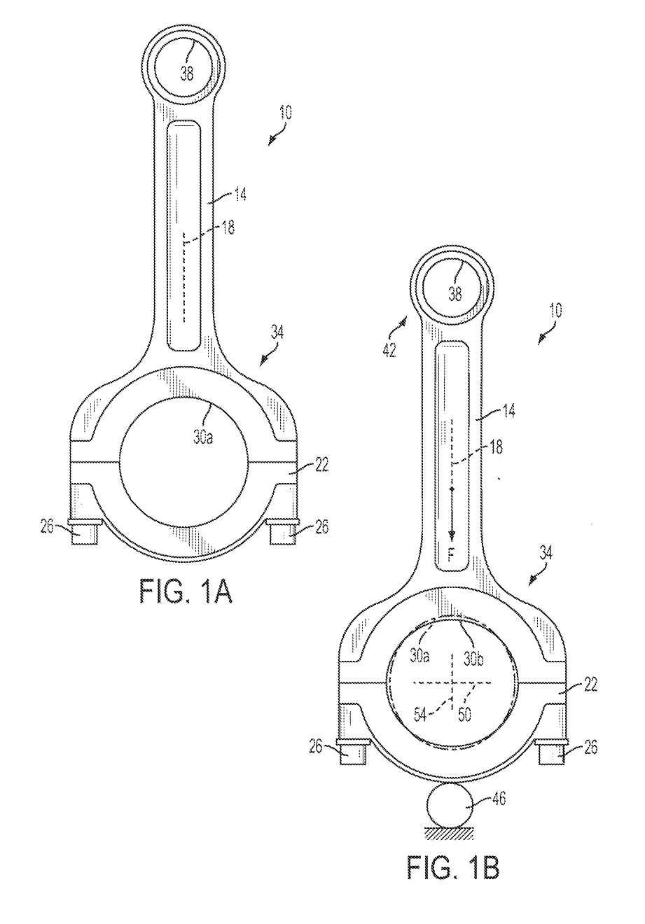

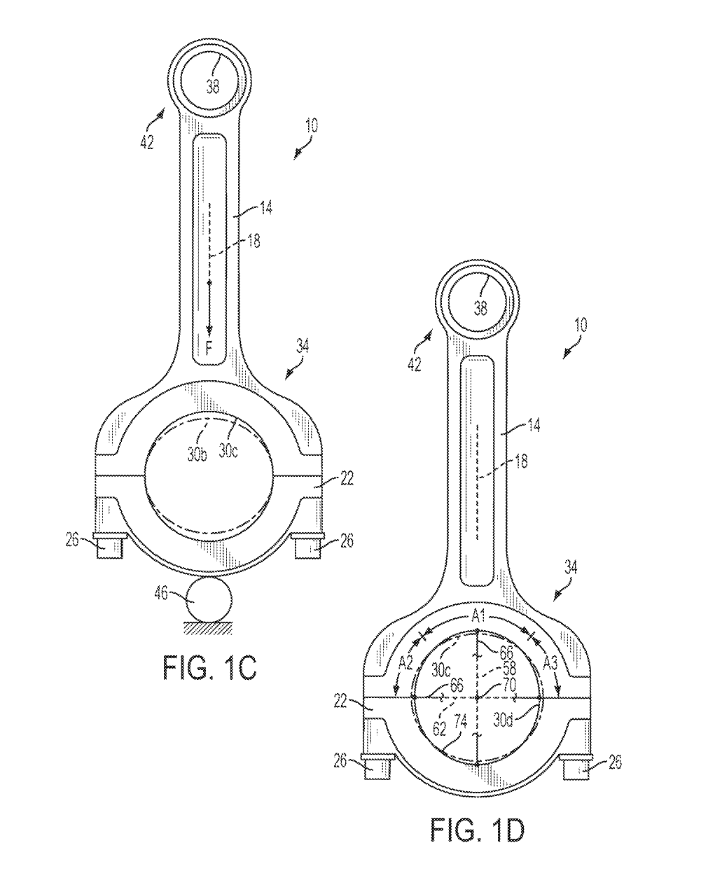

FIGS. 1A-1D illustrate a first method of manufacturing a connecting rod 10 according to the invention. FIG. 1A illustrates a connecting rod 10 including a body 14 defining a longitudinal axis 18, and a cap 22 coupled to the body 14. In the illustrated construction of the connecting rod 10, the cap 22 is coupled to the body 14 using fasteners 26 (e.g., bolts). Alternatively, any of a number of different components may be used to couple the cap 22 to the body 14. As a further alternative, the connecting rod 10 may be integrally formed as a single piece, such that the cap 22 is integral with the body 14. Such a connecting rod 10 may be used, for example, with an engine having a cantilevered crankshaft.

The connecting rod 10 includes a first bore 30a disposed proximate one end 34 of the connecting rod 10, and a second bore 38 disposed proximate an opposite end 42 of the connecting rod 10. The end 34 of the connecting rod 10 having the first bore 30a is otherwise known as the “big end” 34 of the connecting rod 10, to which a crankshaft journal is rotatably coupled. The end 42 of the connecting rod 10 having the second bore 38 is otherwise known as the “small end” 42 of the connecting rod 10, to which a piston is pivotably coupled. The illustrated connecting rod 10 is configured for use with an internal combustion engine. Alternatively, the connecting rod 10 may be configured in any of a number of different manners for use in different applications.

The body 14 and cap 22 of the connecting rod 10 may be initially made in any of a number of different ways. For example, the body 14 and cap 22 may be separately formed (e.g., using a casting or forging process, etc.) and subsequently coupled using the fasteners 26. Alternatively, the body 14 and cap 22 may be integrally formed as a single piece, then split apart in a later manufacturing process. Either way, the first bore 30a is initially formed as a substantially cylindrical, rough bore 30a defined at least partially by the body 14 and the cap 22. In other words, the rough bore 30 has not yet been machined to a final size.

FIG. 1B illustrates the big end 34 of the connecting rod 10 subjected to a compressive load to at least partially deform the rough bore 30a to a non-cylindrical shape. As shown in FIG. 1B, a single fixed support 46 is aligned with the longitudinal axis 18, and a load F is applied to the body 14 of the connecting rod 10 in the direction of the support 46 to compress or clamp the big end 34 of the connecting rod 10. The magnitude of the clamping load F on the big end 34 of the connecting rod 10 is sized to approximate the compression loading applied to the connecting rod 10 during a compression stroke in an internal combustion engine. The resultant compression or clamping of the big end 34 of the connecting rod 10 causes the substantially cylindrical rough bore 30a (shown in phantom in FIG. 1B) to deform and assume an oblong, non-cylindrical shape (shown in solid in FIG. 1B). Specifically, the deformed, non-cylindrical rough bore 30b assumes an oblong shape having a major axis 50 oriented substantially normal to the longitudinal axis 18, and a minor axis 54 oriented substantially parallel to the longitudinal axis 18. In other words, the deformed, non-cylindrical rough bore 30b includes a minimum radius oriented along the minor axis 54, and a maximum radius oriented along the major axis 50. With the particular oblong shape shown in FIG. 1B, the radius of the deformed, non-cylindrical rough bore 30b continuously increases from the minimum radius (oriented along the minor axis 54) to the maximum radius (oriented along the major axis 50). Likewise, the radius of the deformed, non-cylindrical rough bore 30b continuously decreases from the maximum radius (oriented along the major axis 50) to the minimum radius (oriented along the minor axis 54).

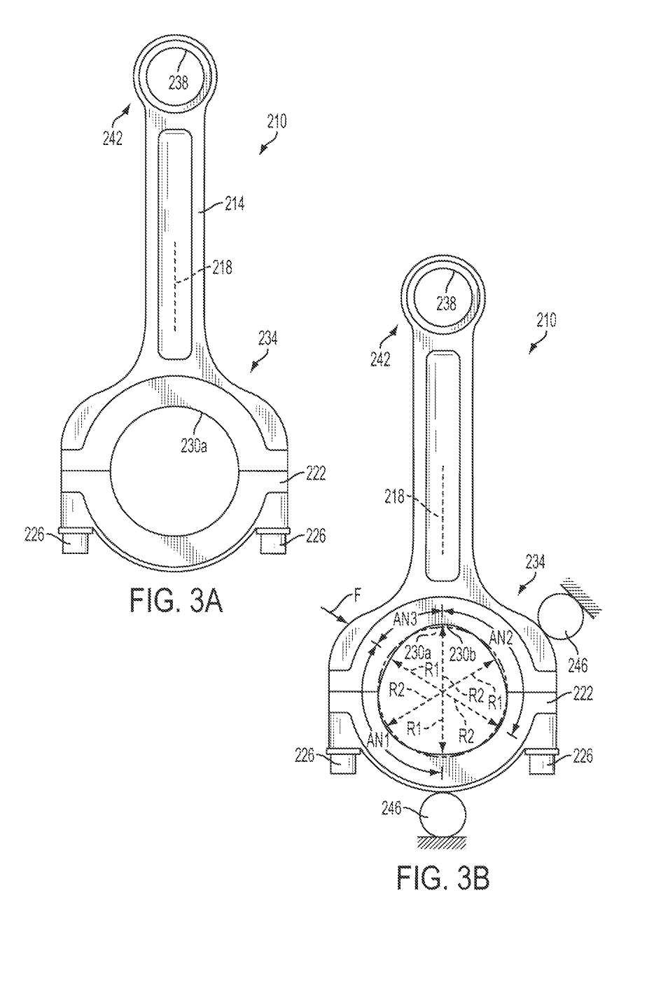

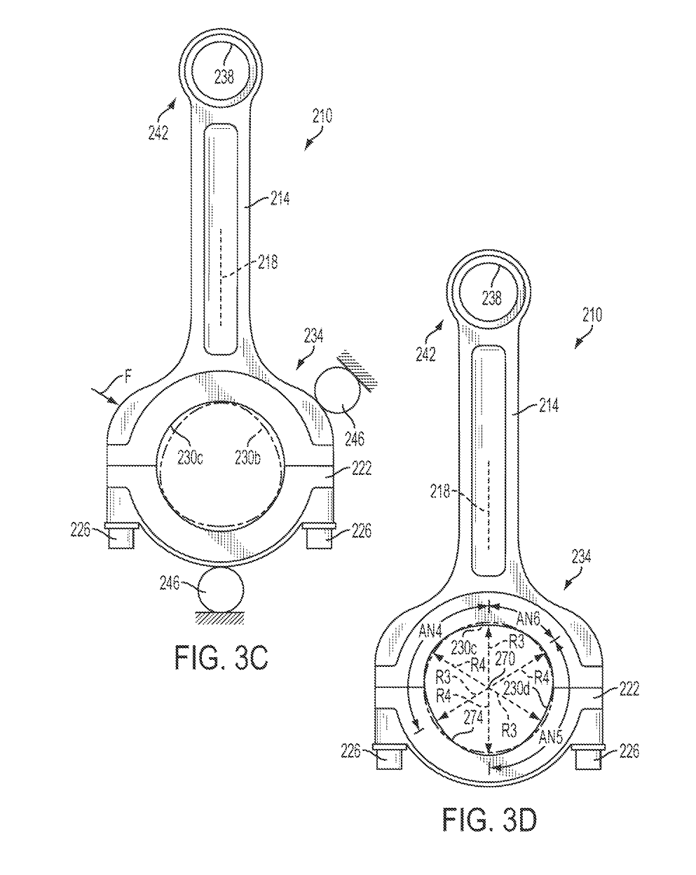

Alternatively, more than one support 46 may be utilized, and the supports 46 may be positioned relative to each other (i.e., spaced more closely to each other or further from each other), or spaced from the longitudinal axis 18, in any of a number of different configurations to yield a deformed, non-cylindrical shape different than the shape of the deformed, non-cylindrical rough bore 30b shown in FIG. 1B (see FIG. 3B).

With reference to FIG. 1C, the deformed, non-cylindrical rough bore 30b (shown in phantom) is next machined to a substantially cylindrical, finished bore 30c (shown in solid) while the clamping load F is maintained on the big end 34 of the connecting rod 10. Subsequently, the clamping load F is released, and the finished bore 30d is allowed to assume an oblong shape upon the connecting rod 10 elastically resuming its undeformed shape (see FIG. 1D). Specifically, the finished bore 30d assumes an oblong shape having a major axis 58 oriented substantially parallel to the longitudinal axis 18, and a minor axis 62 oriented substantially normal to the longitudinal axis 18. With the particular oblong shape assumed by the undeformed, non-cylindrical finished bore 30d shown in FIG. 1D, a chord 66 bounded by the shape or outer periphery of the finished bore 30d, and intersecting a central axis 70 of the finished bore 30d, continuously decreases in length from a first orientation (i.e., vertical), in which the chord 66 is aligned with the major axis 58, to a second orientation (i.e., horizontal), in which the chord 66 is aligned with the minor axis 62, as the chord 66 is rotated about the central axis 70 of the finished bore 30d. In other words, the undeformed, non-cylindrical finished bore 30d is defined by a single, continuous surface lacking any discontinuities (e.g., an apex or a dip in the surface that deviates from the generally arcuate shape of the finished bore 30d).

When assembled as part of an internal combustion engine, a plurality of rolling elements (e.g., cylindrical rollers) are positioned within the radial space between the outer surface of the crankshaft journal and an inner surface 74 of the connecting rod 10 defining the finished bore 30d. When the engine is not operating, the connecting rod 10 is not subjected to either inertial loading or compression loading, and the finished bore 30d assumes the shape shown in FIG. 1D. Because the finished bore 30d is oblong, the roller bearings situated in the region corresponding with arc length A1 in FIG. 1D may be spaced from the inner surface 74 of the connecting rod 10, leaving the roller bearings situated in the region corresponding with the arc lengths A2, A3 in FIG. 1D in contact with the inner surface 74 of the connecting rod 10.

During operation of the engine, compression loading on the connecting rod 10 (as applied by the expanding combustion gases in the cylinder acting on the piston) causes the finished bore 30d to again assume the substantially cylindrical shape 30c shown in solid in FIG. 1C, thereby expanding the contact zone or region with the rolling elements to include the region corresponding with the arc length A1 shown in FIG. 1D. As a result, the total area of the inner surface 74 with which the rolling elements are in contact increases, thereby reducing the stress on the rolling elements. This manner of operation of the connecting rod 10 is made possible by the manufacturing process discussed above, in which the big end 34 of the connecting rod 10 is subjected to the clamping load F, which simulates the compression loading on the connecting rod 10 during operation of the engine, and the connecting rod 10 is machined to create the finished bore 30c while the clamping load F is maintained on the big end 34 of the connecting rod 10. In this manner, the shape of the finished bore 30c is assured to be substantially cylindrical when the connecting rod 10 is subjected to compression loading during engine operation.

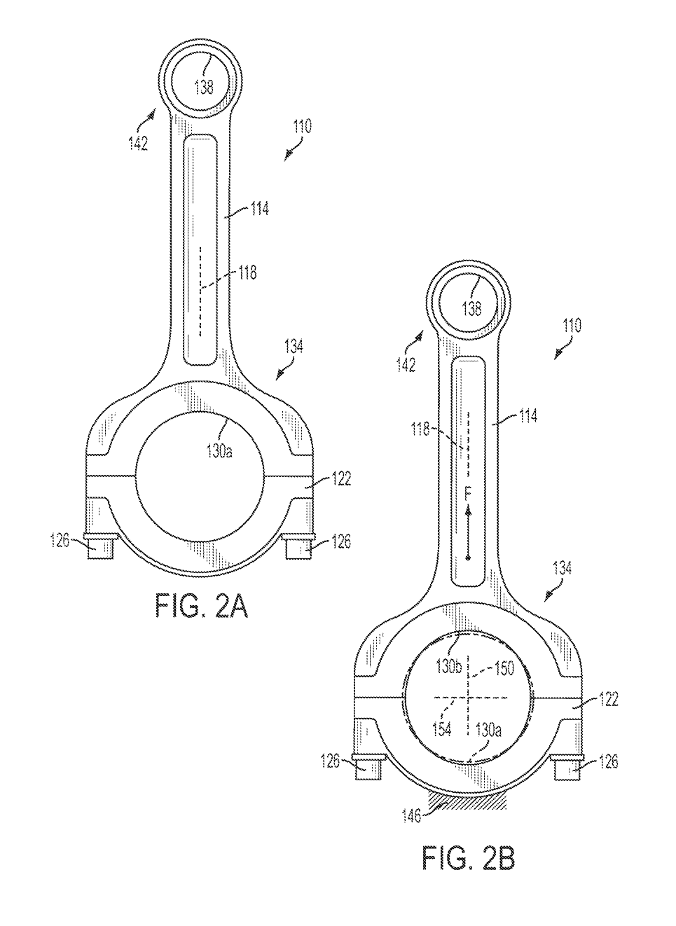

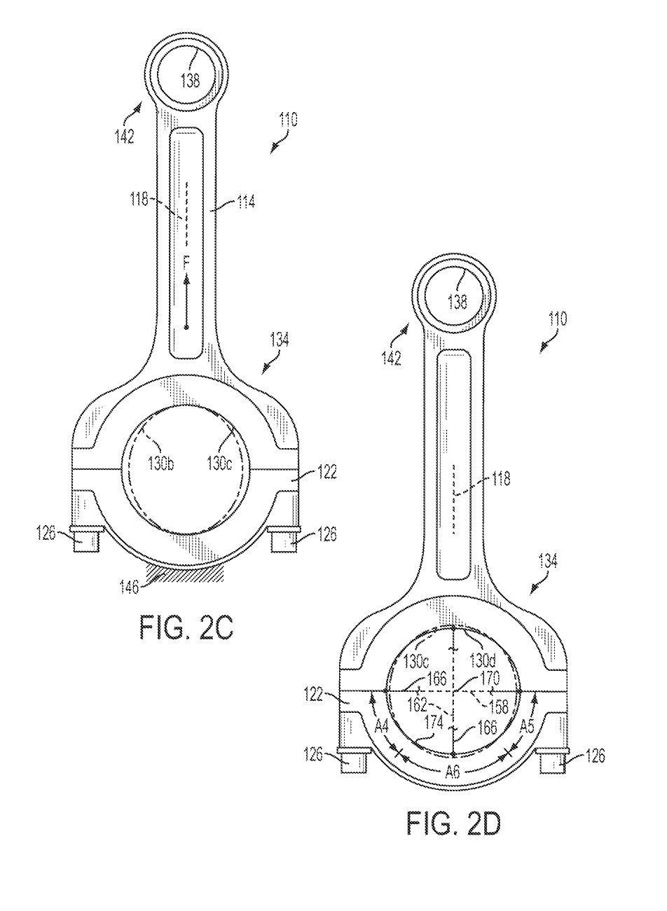

FIGS. 2A-2D illustrate a second method of manufacturing a connecting rod 110 according to the invention. FIG. 2A illustrates a connecting rod 110 including a body 114 defining a longitudinal axis 118 and a cap 122 coupled to the body 114. In the illustrated construction of the connecting rod 110, the cap 122 is coupled to the body 114 using fasteners 126 (e.g., bolts). Alternatively, any of a number of different components may be used to couple the cap 122 to the body 114. The connecting rod 10 includes a first bore 130a disposed proximate a big end 134 of the connecting rod 110, and a second bore 138 disposed proximate a small end 142 of the connecting rod 110. The illustrated connecting rod 110 is configured for use with an internal combustion engine. Alternatively, the connecting rod 110 may be configured in any of a number of different manners for use in different applications.

In a similar manner as the connecting rod of FIGS. 1A-1D, the first bore 130a is initially formed as a substantially cylindrical, rough bore 130a defined at least partially by the body 114 and the cap 122. FIG. 2B illustrates the big end 134 of the connecting rod 110 subjected to a tensile load F to at least partially deform the rough bore 130a to a non-cylindrical shape. As shown in FIG. 2B, the cap 122 is secured or clamped to a fixed support 146 or other structure, and a load F is applied to the body 114 of the connecting rod 110 in a direction away from the support 146 to stretch the big end 134 of the connecting rod 110. The magnitude of the tensile load F on the big end 134 of the connecting rod 110 is sized to approximate the inertial loading applied to the connecting rod 110 by the piston when changing directions (e.g., between an exhaust stroke and an intake stroke) during operation of the engine. The resultant stretching of the big end 134 of the connecting rod 110 causes the substantially cylindrical rough bore 130a (shown in phantom in FIG. 2B) to deform and assume an oblong, non-cylindrical shape (shown in solid in FIG. 2B).

Specifically, the deformed, non-cylindrical rough bore 130b assumes an oblong shape having a major axis 150 oriented substantially parallel to the longitudinal axis 118, and a minor axis 154 oriented substantially normal to the longitudinal axis 118. In other words, the deformed, non-cylindrical rough bore 130b includes a minimum radius oriented along the minor axis 154, and a maximum radius oriented along the major axis 150. With the particular oblong shape shown in FIG. 2B, the radius of the deformed, non-cylindrical rough bore 130b continuously increases from the minimum radius (oriented along the minor axis 154) to the maximum radius (oriented along the major axis 150). Likewise, the radius of the deformed, non-cylindrical rough bore 130b continuously decreases from the maximum radius (oriented along the major axis 150) to the minimum radius (oriented along the minor axis 154).

With reference to FIG. 2C, the deformed, non-cylindrical rough bore 130b (shown in phantom) is next machined to a substantially cylindrical, finished bore 130c (shown in solid) while the tensile load F is maintained on the big end 134 of the connecting rod 110. Subsequently, the tensile load F is released, and the finished bore 130c is allowed to assume an oblong shape upon the connecting rod 110 elastically resuming its undeformed shape (see FIG. 2D). Specifically, the finished bore 130d assumes an oblong shape having a major axis 158 oriented substantially normal to the longitudinal axis 118, and a minor axis 162 oriented substantially parallel to the longitudinal axis 118. With the particular oblong shape assumed by the undeformed, non-cylindrical finished bore 130d shown in FIG. 2D, a chord 166 bounded by the shape or outer periphery of the finished bore 130d, and intersecting a central axis 170 of the finished bore 130d, continuously decreases in length from a first orientation (i.e., horizontal), in which the chord 166 is aligned with the major axis 158, to a second orientation (i.e., vertical), in which the chord 166 is aligned with the minor axis 162, as the chord 166 is rotated about the central axis 170 of the finished bore 130d. In other words, the undeformed, non-cylindrical finished bore 130d is defined by a single, continuous surface lacking any discontinuities (e.g., an apex or a dip in the surface that deviates from the generally arcuate shape of the finished bore 130d).

When assembled as part of an internal combustion engine, a plurality of rolling elements (e.g., cylindrical rollers) are positioned within the radial space between the outer surface of the crankshaft journal and an inner surface 174 of the connecting rod 110 defining the finished bore 130d. When the engine is not operating, the connecting rod 110 is not subjected to either inertial loading or compression loading, and the finished bore 130d assumes the shape shown in FIG. 2D. Because the finished bore 130d is oblong, the rolling elements situated in the region corresponding with arc lengths A4, A5 in FIG. 2D may be spaced from the inner surface 174 of the connecting rod 110, leaving the rolling elements situated in the region corresponding with the arc length A6 in FIG. 2D in contact with the inner surface 174 of the connecting rod 110.

During operation of the engine, inertial loading on the connecting rod 110 causes the finished bore 130d to again assume the substantially cylindrical shape 130c shown in solid in FIG. 2C, thereby expanding the contact zone or region with the rolling elements to include the region corresponding with the arc lengths A4,A5 shown in FIG. 2D. As a result, the total area of the inner surface 174 with which the rolling elements are in contact increases, thereby reducing the stress on the rolling elements. This manner of operation of the connecting rod 110 is made possible by the manufacturing process discussed above, in which the big end 134 of the connecting rod 110 is subjected to a tensile load F, which simulates the inertial loading on the connecting rod 110 during operation of the engine, and the connecting rod 110 is machined to create the finished bore 130c while the tensile load F is maintained on the big end 134 of the connecting rod 110. In this manner, the shape of the finished bore 130c is assured to be substantially cylindrical when the connecting rod 110 is subjected to inertial loading during engine operation.

In an alternative manufacturing process, the rough bore 30a, 130a in the big end 34, 134 of the connecting rod 10, 110 may be machined to take into account the deformation experienced by the finished bore 30d, 130d during both compression loading and inertial loading of the connecting rod 10, 110. Such a manufacturing process would yield a connecting rod having a finished bore, in which the top half of the finished bore 30d would resemble the top half of the finished bore 30d shown in FIG. 1D, and in which the bottom half of the finished bore would resemble the bottom half of the finished bore 130d shown in FIG. 2D. The finished bore, however, would be machined to yield a single, continuous surface lacking any discontinuities (e.g., an apex or a dip in the surface that deviates from the generally arcuate shape of the finished bore).

FIGS. 3A-3D illustrate a third method of manufacturing a connecting rod 210 according to the invention. FIG. 3A illustrates a connecting rod 210 including a body 214 defining a longitudinal axis 218, and a cap 222 coupled to the body 214. In the illustrated construction of the connecting rod 210, the cap 222 is coupled to the body 214 using fasteners 226 (e.g., bolts). Alternatively, any of a number of different components may be used to couple the cap 222 to the body 214. As a further alternative, the connecting rod 210 maybe integrally formed as a single piece, such that the cap 222 is integral with the body 214. Such a connecting rod 210 may be used, for example, with an engine having a cantilevered crankshaft.

The connecting rod 210 includes a first bore 230a disposed proximate one end 234 of the connecting rod 210, and a second bore 238 disposed proximate an opposite end 242 of the connecting rod 210. The end 234 of the connecting rod 210 having the first bore 230a is otherwise known as the “big end” 234 of the connecting rod 210, to which a crankshaft journal is rotatably coupled. The end 242 of the connecting rod 210 having the second bore 238 is otherwise known as the “small end” 242 of the connecting rod 210, to which a piston is pivotably coupled. The illustrated connecting rod 210 is configured for use with an internal combustion engine. Alternatively, the connecting rod 210 may be configured in any of a number of different manners for use in different applications.

The body 214 and cap 222 of the connecting rod 210 may be initially made in any of a number of different ways. For example, the body 214 and cap 222 may be separately formed (e.g., using a casting or forging process, etc.) and subsequently coupled using the fasteners 226. Alternatively, the body 214 and cap 222 may be integrally formed as a single piece, then split apart in a later manufacturing process. Either way, the first bore 230a is initially formed as a substantially cylindrical, rough bore 230a defined at least partially by the body 214 and the cap 222. In other words, the rough bore 230 has not yet been machined to a final size.

FIG. 3B illustrates the big end 234 of the connecting rod 210 subjected to a compressive load to at least partially deform the rough bore 230a to a non-cylindrical shape. As shown in FIG. 1B, dual fixed supports 246 are engaged with the body 214, and a load F is applied to the body 214 of the connecting rod 210 to compress or clamp the big end 234 of the connecting rod 210. The magnitude of the clamping load F on the big end 234 of the connecting rod 210 is sized to approximate the compression loading applied to the connecting rod 210 during a compression stroke in an internal combustion engine. The resultant compression or clamping of the big end 234 of the connecting rod 210 causes the substantially cylindrical rough bore 230a (shown in phantom in FIG. 3B) to deform and assume a non-cylindrical shape (shown in solid in FIG. 3B). Specifically, the deformed, non-cylindrical rough bore 230b assumes a non-cylindrical shape defined by a plurality (e.g., three) of minimum radii R1 and a plurality (e.g., three) of maximum radii R2. As shown in FIG. 3B, adjacent minimum radii R1 are angularly spaced by an angle AN1 of about 120 degrees. Likewise, adjacent maximum radii R2 are angularly spaced by an angle AN2 of about 120 degrees. Further, each minimum radius R1 is angularly spaced from an adjacent maximum radius R2 by an angle AN3 of about 60 degrees. The radius of the non-cylindrical shape continuously increases from each minimum radius R1 to an adjacent maximum radius R2. Likewise, the radius of the non-cylindrical shape continuously decreases from each maximum radius R2 to an adjacent minimum radius R1.

With continued reference to FIG. 3B, the supports 246 may be positioned relative to each other (i.e., spaced more closely to each other or further from each other), or spaced from the longitudinal axis 218, in any of a number of different configurations to yield a deformed, non-cylindrical shape different than the shape of the deformed, non-cylindrical rough bore 230b shown in FIG. 3B. Alternatively, more than two supports 246 may be utilized to yield a deformed, non-cylindrical rough bore having more minimum and maximum radii R1, R2 than that shown in FIG. 3B.

With reference to FIG. 3C, the deformed, non-cylindrical rough bore 230b (shown in phantom) is next machined to a substantially cylindrical, finished bore 230c (shown in solid) while the clamping load F is maintained on the big end 234 of the connecting rod 210. Subsequently, the clamping load F is released, and the finished bore 230d is allowed to assume a non-cylindrical shape that is substantially the inverse of the deformed, non-cylindrical shape shown in FIG. 3B when the connecting rod 210 elastically recovers (see FIG. 3D). Specifically, the finished bore 230d assumes a non-cylindrical cross-sectional shape, through a plane oriented substantially normal to a central axis 270 of the finished bore 230d, having three minimum radii R3 equi-angularly spaced about the central axis 270 (e.g., by an angle AN4 of about 120 degrees), and three maximum radii R4 equi-angularly spaced about the central axis 270 (e.g., by an angle AN5 of about 120 degrees). Further, each minimum radius R3 is angularly spaced from an adjacent maximum radius R4 by an angle AN6 of about 60 degrees. Between adjacent radii R3, R4, the radius of the finished bore 230d continuously increases from the minimum radius R3 to the maximum radius R4. Likewise, between adjacent radii R4, R3, the radius of the finished bore 230d continuously decreases from the maximum radius R4 to the minimum radius R3. As a result, the undeformed, non-cylindrical finished bore 230d is defined by a single, continuous surface lacking any discontinuities (e.g., a discrete apex or a dip in the surface that deviates from the generally arcuate shape of the finished bore 230d).

When assembled as part of an internal combustion engine, a plurality of rolling elements (e.g., cylindrical rollers) are positioned within the radial space between the outer surface of the crankshaft journal and an inner surface 274 of the connecting rod 210 defining the finished bore 230d. When the engine is not operating, the connecting rod 10 is not subjected to either inertial loading or compression loading, and the finished bore 230d assumes the shape shown in FIG. 3D. Because the finished bore 230d is non-cylindrical, the roller bearings situated in the region proximate each of the maximum radii R4 may be spaced from the inner surface 274 of the connecting rod 210, leaving the roller bearings situated in the region proximate each of the minimum radii R3 in contact with the inner surface 274 of the connecting rod 210.

During operation of the engine, compression loading on the connecting rod 210 (as applied by the expanding combustion gases in the cylinder acting on the piston) causes the finished bore 230d to again assume the substantially cylindrical shape 230c shown in solid in FIG. 3C, thereby expanding the contact zone or region with the rolling elements to include the regions proximate the maximum radii R4 associated with the body 214 of the connecting rod 210. As a result, the total area of the inner surface 274 with which the rolling elements are in contact increases, thereby reducing the stress on the rolling elements. This manner of operation of the connecting rod 210 is made possible by the manufacturing process discussed above, in which the big end 234 of the connecting rod 210 is subjected to the clamping load F, which simulates the compression loading on the big end 234 of the connecting rod 210 during operation of the engine, and the connecting rod 210 is machined to create the finished bore 230c while the clamping load F is maintained on the big end 234 of the connecting rod 210. In this manner, the shape of the finished bore 230c is assured to be substantially cylindrical when the connecting rod 210 is subjected to compression loading during engine operation.

Various features of the invention are set forth in the following claims.

What is claimed is:

1. A method of manufacturing a connecting rod, the method comprising:
providing a substantially cylindrical rough bore in one end of the connecting rod;
applying one of a compressive load and a tensile load to the connecting rod to at least partially deform the rough bore to a non-cylindrical shape; and
machining the deformed rough bore to a substantially cylindrical shape while the one of the compressive load and the tensile load is applied to the connecting rod.

2. The method of claim 1, wherein applying the one of the compressive load and the tensile load to the connecting rod includes forming the non-cylindrical shape of the deformed rough bore with a minimum, first radius and a maximum, second radius with respect to a central axis of the bore.

3. The method of claim 2, wherein forming the non-cylindrical shape of the deformed rough bore includes forming the non-cylindrical shape such that the radius of the non-cylindrical shape continuously increases from the first radius to the second radius.

4. The method of claim 2, wherein forming the non-cylindrical shape of the deformed rough bore includes forming the non-cylindrical shape such that the radius of the non-cylindrical shape continuously decreases from the second radius to the first radius.

5. The method of claim 1, wherein applying the compressive load to the connecting rod includes deforming the rough bore to an oblong shape having a major axis oriented substantially normal to a longitudinal axis of the connecting rod.

6. The method of claim 1, wherein applying the tensile load to the connecting rod includes deforming the rough bore to an oblong shape having a major axis oriented substantially parallel to a longitudinal axis of the connecting rod.

7. The method of claim 1, wherein applying one of the compressive load and the tensile load includes orienting the one of the compressive load and the tensile load in a direction parallel to a longitudinal axis of the connecting rod.

8. The method of claim 7, further comprising positioning at least one support adjacent the end of the connecting rod having the substantially cylindrical rough bore, wherein applying the compressive load to the end of the connecting rod includes clamping the connecting rod against the support.

9. The method of claim 8, wherein positioning the least one support adjacent the end of the connecting rod includes positioning at least two supports adjacent the end of the connecting rod.

10. The method of claim 9, further comprising adjusting a spacing between the at least two supports prior to applying the compressive load to at least partially deform the rough bore to the non-cylindrical shape.

11. The method of claim 8, further comprising positioning at least one support adjacent the end of the connecting rod having the substantially cylindrical rough bore, wherein applying the tensile load to the connecting rod includes securing the end of the connecting rod to the support.

12. The method of claim 1, wherein the connecting rod includes a body and a cap coupled to the body, wherein providing the substantially cylindrical rough bore includes providing the substantially cylindrical rough bore at least partially in the body and the cap.

13. The method of claim 1, further comprising releasing the one of the compressive load and the tensile load after machining the deformed rough bore, and wherein releasing the one of the compressive load and the tensile load includes permitting the machined bore to assume a second deformed, non-cylindrical shape.

14. A connecting rod comprising:
a body defining a longitudinal axis;
a cap coupled to the body; and
a non-cylindrical, finished bore defined at least partially by the body and the cap, the finished bore defining a central axis oriented substantially normal to the longitudinal axis, the finished bore having a cross-sectional shape through a plane oriented substantially normal to the central axis, the cross-sectional shape having a minimum, first radius and a maximum, second radius with respect to the central axis;
wherein the radius of the cross-sectional shape continuously increases from the first radius to the second radius.

15. The connecting rod of claim 14, wherein the radius of the non-cylindrical shape continuously decreases from the second radius to the first radius.

16. A connecting rod comprising:
a body defining a longitudinal axis;
a cap coupled to the body; and
an oblong, finished bore defined at least partially by the body and the cap, the finished bore defining a central axis oriented substantially normal to the longitudinal axis, the finished bore having a cross-sectional shape through a plane oriented substantially normal to the central axis, the cross-sectional shape having a major axis and a minor axis;
wherein one of the major axis and the minor axis is oriented substantially parallel with the longitudinal axis, and wherein a chord bounded by the cross-sectional shape of the finished bore and intersecting the central axis continuously decreases in length from a first orientation, in which the chord is aligned with the major axis, to a second orientation, in which the chord is aligned with the minor axis, as the chord is rotated about the central axis.
